(19) United States
(12) Patent Application Publication
(10) Pub. No.: US 2020/0156657 A1
(43) Pub. Date: May 21, 2020

(54) Information Control Apparatus

(71) Applicant: Marelli Corporation, Saitama-shi, Saitama (JP)

(72) Inventors: Yuusuke Tanizawa, Saitama-shi, Saitama (JP); Teruo Yoshitomi, Saitama-shi, Saitama (JP); Haruhiko Satou, Saitama-shi, Saitama (JP); Soichiro Aoyagi, Saitama-shi, Saitama (JP)

(21) Appl. No.: 16/632,773

(22) PCT Filed: Jun. 19, 2018
(86) PCT No.: PCT/JP2018/023349

§ 371 Date: Jan. 21, 2020

(30) Foreign Application Priority Data
Jul. 24, 2017 (JP) 2017-142805

(51) Int. Cl. B60W 50/14; G08G 1/0967

(52) U.S. Cl. CPC B60W 50/14; B60W 2050/146; G08G 1/096716

(57) ABSTRACT

An information control apparatus is capable of optimizing control of output information based on the volume of information of the surroundings of a vehicle. The information control apparatus includes a vehicle information acquisition interface that acquires information related to a vehicle, a driver information acquisition interface that acquires information related to a driver, and a controller that calculates a first volume of information of surroundings of the vehicle based on the information related to the vehicle and the information related to the driver and controls output information based on the first volume of information.

### CROSS-REFERENCE TO RELATED APPLICATION

The present application claims priority to and the benefit of Japanese Patent Application No. 2017-142805 filed Jul. 24, 2017, the entire contents of which are incorporated herein by reference.

### TECHNICAL FIELD

The present disclosure relates to an information control apparatus mounted in a vehicle.

### BACKGROUND

A variety of information is outputted to a car navigation apparatus mounted in a vehicle, allowing a driver or the like to obtain necessary information.

The car-mounted navigation apparatus disclosed in patent literature JP4376295B2 changes an outputted logo mark to be more visible in accordance with vehicle driving conditions such as the vehicle speed, the type of road the vehicle is being driven on, and the frequency of use of facilities.

### SUMMARY

A predetermined monitor mounted in a vehicle typically cannot output information that is not directly related to driving while the car is moving. On the other hand, a predetermined monitor mounted in a vehicle can output any information, regardless of the conditions surrounding the vehicle, when the vehicle is completely stopped. Such output control may not be optimal, however, when considering the environment around the vehicle.

The present disclosure has been conceived in light of this problem and provides an information control apparatus that can optimize control of output information based on the volume of information of the surroundings of a vehicle.

To resolve the aforementioned problem, an information control apparatus according to an embodiment of the present disclosure includes:

a vehicle information acquisition interface configured to acquire information related to a vehicle;

a driver information acquisition interface configured to acquire information related to a driver; and

a controller configured to calculate a first volume of information of surroundings of the vehicle based on the information related to the vehicle and the information related to the driver and to control output information based on the first volume of information.

An information control apparatus according to an embodiment of the present disclosure can optimize control of output information based on the volume of information of the surroundings of a vehicle.

### BRIEF DESCRIPTION OF THE DRAWINGS

In the accompanying drawings:

FIG. 1 is a block diagram illustrating an information control apparatus according to an embodiment;

FIG. 2 is a schematic diagram illustrating the configuration of an output interface of FIG. 1;

FIG. 3 is a first flowchart illustrating an example of output information control executed by a controller of FIG. 1; and

FIG. 4 is a second flowchart illustrating an example of output information control executed by the controller of FIG. 1.

### DETAILED DESCRIPTION

Embodiments of the present disclosure are described below with reference to the drawings.

An information control apparatus 1 according to an embodiment calculates the volume of information of vehicle surroundings (first volume of information) based on vehicle-related information and driver-related information. The information control apparatus 1 controls output information based on this volume of information.

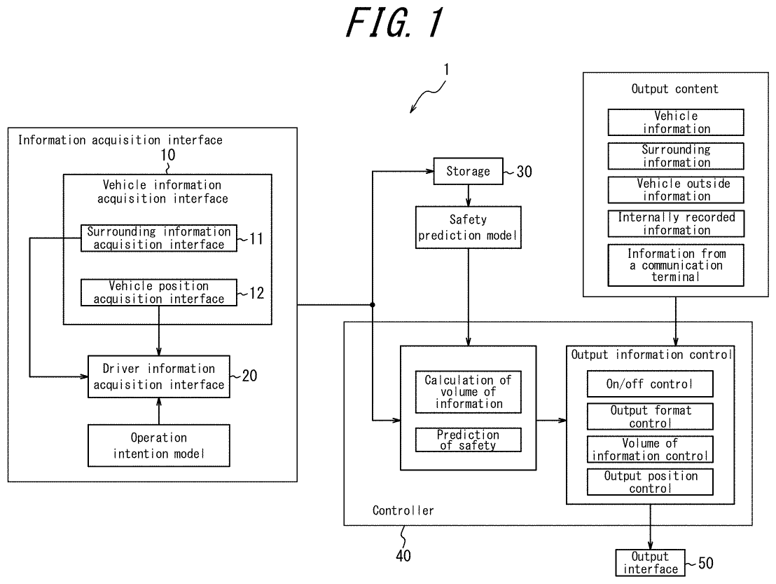

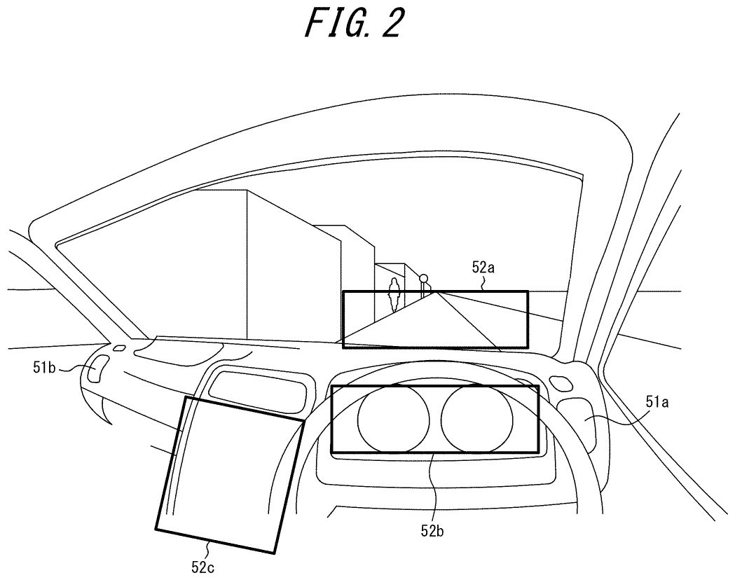

FIG. 1 is a block diagram illustrating the information control apparatus 1 according to an embodiment. FIG. 2 is a schematic diagram illustrating the configuration of an output interface 50 of FIG. 1. The information control apparatus 1 includes an information acquisition interface, a storage 30, a controller 40, and the output interface 50. The information acquisition interface is configured by a vehicle information acquisition interface 10 and a driver information acquisition interface 20.

The vehicle information acquisition interface 10 includes a surrounding information acquisition interface 11 and a vehicle position acquisition interface 12. The vehicle information acquisition interface 10 acquires vehicle-related information using the surrounding information acquisition interface 11 and the vehicle position acquisition interface 12. The vehicle-related information includes environment information around the vehicle and the current position of the vehicle, as described below.

The vehicle information acquisition interface 10 acquires various other vehicle-related information. The vehicle information acquisition interface 10 may, for example, acquire various information related to vehicle conditions using a controller area network (CAN), which is one communication method in an in-vehicle network. For example, the vehicle information acquisition interface 10 may acquire information related to vehicle conditions such as the vehicle speed, accelerator state, brake state, clutch state, turn signal state, gear state, windshield wiper state, side mirror state, seat state, audio state, warning state, light state, steering state, idle state, air conditioner state, seat belt state, and driving operation level.

The surrounding information acquisition interface 11 is configured by suitable sensors such as a camera, light detection and ranging (LiDAR), and radar. For example, the surrounding information acquisition interface 11 may include appropriate sensors forming an advanced driver-assistance system (ADAS). The surrounding information acquisition interface 11 may include an appropriate communication apparatus for performing vehicle-to-vehicle and road-to-vehicle (V2X) communication. The surrounding information acquisition interface 11 detects traffic participant conditions, such as the characteristics, positions, and movement speed of traffic participants; road conditions, such as the state of the road surface, the distance between lane markings on the road, the type of road, and the number of lanes; traffic light conditions; and the like to acquire environment information around the vehicle. The surrounding information acquisition interface 11 may acquire information related to at least one of the conditions of vehicles ahead, conditions of vehicles behind, conditions of vehicles in parallel, and conditions of intersecting vehicles. Additionally, the surrounding information acquisition interface 11 may acquire environment information around the vehicle such as information related to the state of communication with an external network, information related to conditions of moving objects in the surrounding sky, external server information, and point of interest (POI) information.

The vehicle position acquisition interface 12 is configured by a navigation system or the like. The vehicle position acquisition interface 12 calculates the current position of the vehicle indicated by the latitude, longitude, altitude, inclination, lane position, and the like of the vehicle. The vehicle position acquisition interface 12 may acquire information related to vehicle position conditions, such as the temperature, humidity, weather, brightness, degree of transparency, and the like at the current position of the vehicle.

The driver information acquisition interface 20 is configured by appropriate sensors, such as a camera and a wearable sensor, and a control CAN or the like. The driver information acquisition interface 20 acquires driver-related information. For example, the driver information acquisition interface 20 acquires information related to driver operations. In particular, the driver information acquisition interface 20 detects driving operations by the driver. The driver information acquisition interface 20 additionally acquires information related to the operation intention of the driver based on vehicle-related information, acquired by the surrounding information acquisition interface 11 and the vehicle position acquisition interface 12, and an operation intention model stored in the storage 30 or the like. The driver information acquisition interface 20 detects the driving operation intention of the driver.

For example, the driver information acquisition interface 20 acquires information related to operations by the driver such as an accelerator operation, brake operation, clutch operation, turn signal operation, gear operation, windshield wiper operation, side mirror operation, seat operation, audio operation, light operation, steering operation, air conditioner operation, and seat belt operation.

The driver information acquisition interface 20 may acquire other information related to the state of the driver. For example, the driver information acquisition interface 20 may acquire information related to the state of the driver such as the biological state, face orientation, gaze, blinking state, body movement, degree of excitement, degree of sentiment, enjoyment, satisfaction, emotions, desires, continuous driving (riding) time, visibility (glare), audibility, utterances, and the like of the driver. The biological information of the driver may include the degree of arousal, brain waves, cerebral blood flow, blood pressure, blood glucose level, blood amino acids, HbA1c, γ-GPT, blood concentration of medications, heart rate, body temperature, apparent temperature, hunger, fatigue, and the like. The driver information acquisition interface 20 has been described as acquiring these pieces of driver-related information, but this configuration is not limiting. The driver information acquisition interface 20 may acquire similar information related to a passenger.

The above information acquired by the information acquisition interface configured by the vehicle information acquisition interface 10 and the driver information acquisition interface 20 is outputted to the storage 30 and the controller 40.

The storage 30 can be configured by a semiconductor memory, a magnetic memory, or the like. The storage 30 stores the various information described above, programs for causing the information control apparatus 1 to operate, and the like. The storage 30 may also store various data necessary for control of output information by the information control apparatus 1, such as time series data and map data, related to driving behavior of the driver. The storage 30 also functions as a working memory.

The controller 40 is a processor that controls and manages the entire information control apparatus 1, including the functional blocks of the information control apparatus 1. The controller 40 is configured by a processor such as a central processing unit (CPU) that executes programs with prescribed control procedures. Such programs are, for example, stored in the storage 30.

The controller 40 calculates the volume of information of the vehicle surroundings based on the vehicle-related information acquired by the vehicle information acquisition interface 10 and the driver-related information acquired by the driver information acquisition interface 20. The controller 40 may furthermore predict the safety of the vehicle surroundings based on the vehicle-related information and the driver-related information, and based on a safety prediction model stored in the storage 30 or the like. The safety of the vehicle surroundings is predicted based on a plurality of factors, including the volume of information of the vehicle surroundings. When focusing only on the relationship between the volume of information of the vehicle surroundings and the safety, the controller 40 tends, for example, to predict that safety is lower as the volume of information of the vehicle surroundings is larger. Conversely, the controller 40 tends to predict that safety is higher as the volume of information of the vehicle surroundings is smaller.

The vehicle-related information and the driver-related information used to calculate the volume of information of the vehicle surroundings and the safety of the vehicle surroundings each include at least one of the aforementioned various pieces of information acquired by the vehicle information acquisition interface 10 and the driver information acquisition interface 20.

The controller 40 controls output information based on the calculated volume of information of the vehicle surroundings. The controller 40 may control the output information based on the predicted safety of the vehicle surroundings. The controller 40 outputs the controlled output information to the output interface 50 as necessary.

As illustrated in FIG. 1, there are various types of output information, i.e. output content. For example, the output content is broadly classified into vehicle information, surrounding information, vehicle outside information, internally recorded information, and information from a communication terminal. The vehicle information includes information related to the vehicle speed, fuel level, and tire air pressure, for example. The surrounding information includes environment information around the vehicle sensed by the sensors configuring the surrounding information acquisition interface 11. For example, the surrounding information includes information related to the speed limit and other signs. The vehicle outside information includes information on the outside of the vehicle, other than the surrounding information. For example, the vehicle outside information includes external open information, such as map information, infrastructure information, traffic information, and POI information. The internally recorded information includes local information, stored in the storage 30 or the like, that does not correspond to any of the vehicle information, surrounding information, and vehicle outside information. The information from a communication terminal includes information, or a history thereof, acquired via an in-vehicle or personal communication terminal. For example, the information from a communication terminal includes information such as an emergency disaster bulletin, an extra edition, e-mail, a social networking service (SNS) message, news, and weather.

The output interface 50 outputs the output information obtained from the controller 40 as necessary. The output interface 50 may output the output information obtained from the controller 40 as audio information or visual information. As an example, the output interface 50 may be configured by any audio device, such as a speaker, and any display device. The example output interface 50 described below includes two speakers 51a, 51b and three displays, i.e. a head-up display (HUD) 52a, a meter display 52b, and a center display 52c, as illustrated in FIG. 2.

The output interface 50 may play back each of the aforementioned types of output content as audio from at least one of the speakers 51a, 51b. The output interface 50 may display each of the aforementioned types of output content on at least one of the three displays.

The HUD 52a includes a light emitter that emits display information as display light. The HUD 52a reflects the generated display light towards an observer, such as a driver, to display a virtual image beyond the front windshield. The observer is not limited to the driver and may, for example, be a passenger seated in the passenger seat.

The meter display 52b is, for example, disposed in an instrument panel. Apart from the aforementioned various types of output content, the meter display 52b may also display a tachometer or that like that indicates the number of revolutions of the engine and the vehicle speed.

The center display 52c may be configured by any display apparatus, such as a liquid crystal display. The center display 52c is disposed in the instrument panel, for example, when configured by a liquid crystal display. The display apparatus configuring the center display 52c may be a touch panel display or a display incapable of touch operations.

Control of output information performed by the controller 40 is described below in detail.

The controller 40 may turn output related to output information on or off based on the calculated volume of information of the vehicle surroundings. The controller 40 judges whether the calculated volume of information of the vehicle surroundings is excessively large and determines whether to output the output information from the output interface 50. For example, when the volume of information of the vehicle surroundings is excessively large, the controller 40 judges that safety tends to be low and turns output from the output interface 50 off. The controller 40 does not output the output information to the output interface 50. When the volume of information of the vehicle surroundings is not excessively large, the controller 40 judges that safety tends to be high and turns output from the output interface 50 on. The controller 40 outputs the output information to the output interface 50.

The controller 40 may control the output format of the output information based on the calculated volume of information of the vehicle surroundings. When the volume of information of the vehicle surroundings is greater than a predetermined volume, the controller 40 may, for example, determine the output information to be audio information. Conversely, when the volume of information of the vehicle surroundings is less than a predetermined volume, the controller 40 may, for example, determine the output information to be visual information. The “predetermined volume” is the limit on the volume of information of the vehicle surroundings at which outputting the output information as visual information does not place much of a burden on the driver. The predetermined volume may be determined appropriately for each environment surrounding the vehicle and each driver.

The controller 40 may control the information volume (second information volume) of the output information based on the calculated volume of information of the vehicle surroundings. The controller 40 may output the output information from the output interface 50 at an appropriate volume of information that does not place a large burden on the driver in conjunction with the volume of information of the vehicle surroundings. In greater detail, for an environment around the vehicle representing a large burden on the driver, the controller 40 may reduce the volume of information by at least one of summarizing and extracting the output information. For an environment around the vehicle not representing a burden on the driver, the controller 40 may maintain the volume of information without summarizing or extracting the output information.

Here, the controller 40 may determine the volume of information of the output information from a chunk count (number of chunks) defined by a character count, a word count, a count of phrases, icons, and figures, or a count of attention points in graphic form. The controller 40 is not limited to these examples and may determine the volume of information of the output information by any method allowing objective measurement.

The controller 40 may control the output position of output information based on the calculated volume of information of the vehicle surroundings. For example, when outputting information as audio information, the controller 40 may appropriately play back each type of output content from at least one of the speakers 51a, 51b in conjunction with the volume of information of the vehicle surroundings so as not to place a large burden on the driver for listening. When outputting information as visual information, the controller 40 may appropriately display each type of output content on at least one of the three displays in conjunction with the volume of information of the vehicle surroundings so as not to place a large burden on the driver for viewing.

The time until viewing by the driver is thought to depend on the type of display configuring the output interface 50. For example, the HUD 52a is positioned in front of the driver's eyes and overlaps the driver's line of sight when the driver is concentrating on the direction of vehicle movement. The time until viewing is therefore relatively short for the HUD 52a. On the other hand, the center display 52c can display a relatively large volume of information, but the driver needs to move the line of sight to see the center display 52c. The time until viewing is therefore relatively long for the center display 52c.

Accordingly, when the output information is determined to be visual information, and the volume of information of the vehicle surroundings is relatively large, for example, the controller 40 may cause the aforementioned type of output content to be displayed on the HUD 52a, for which the time until viewing by the driver is relatively short. This avoids placing a larger burden on the driver. On the other hand, it is thought that the burden on the driver is small when the volume of information of the vehicle surroundings is relatively small. The controller 40 may therefore prioritize reliable output of a larger volume of output information and cause the aforementioned types of output information to be displayed on the center display 52c, for which the time until viewing is relatively long.

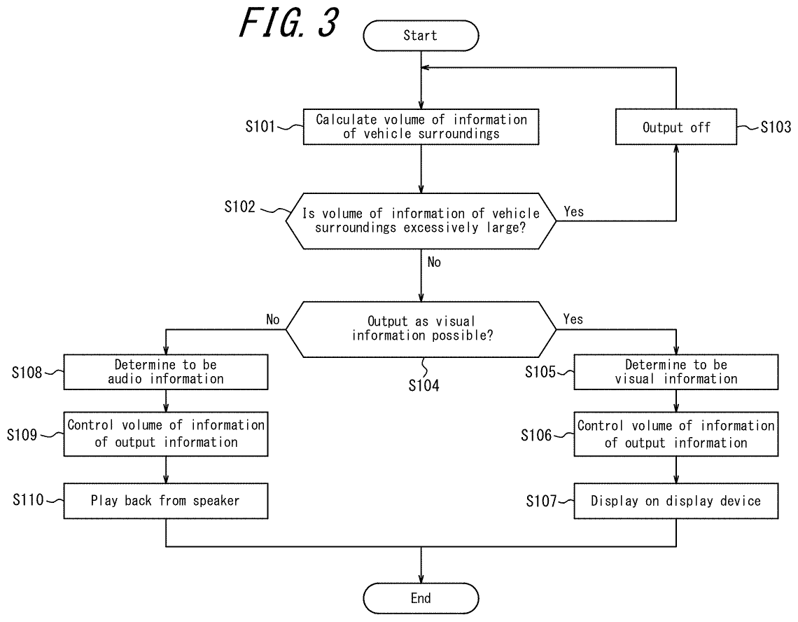

FIG. 3 is a first flowchart illustrating an example of output information control performed by the controller 40 of FIG. 1.

The controller 40 calculates the volume of information of the vehicle surroundings based on the vehicle-related information acquired by the vehicle information acquisition interface 10 and the driver-related information acquired by the driver information acquisition interface 20 (step S101).

The controller 40 judges whether the calculated volume of information of the vehicle surroundings is excessively large (step S102). In other words, the controller 40 judges whether the environment around the vehicle is such that outputting the output information would place an excessive burden on the driver. The controller 40 proceeds to step S103 when judging that the volume of information of the vehicle surroundings is excessive. The controller 40 proceeds to step S104 when judging that the volume of information of the vehicle surroundings is not excessive.

The controller 40 turns output from the output interface 50 off when it was judged that the volume of information of the vehicle surroundings is excessive (step S103). The controller 40 does not output the output information to the output interface 50. Subsequently, the controller 40 returns to step S101 and repeats the same steps.

The controller 40 judges whether the output information can be outputted as visual information when it was judged that the volume of information of the vehicle surroundings is not excessive (step S104). The controller 40 judges whether the environment around the vehicle is such that outputting visual information would not place much of a burden on the driver. In greater detail, the controller 40 judges whether the volume of information of the vehicle surroundings is small enough for output as visual information. The controller 40 proceeds to step S105 when judging that output as visual information is possible. The controller 40 proceeds to step S108 when judging that output as visual information is not possible.

The controller 40 determines the output information to be visual information when it is judged that output as visual information is possible (step S105). The controller 40 determines the output information to be visual information when it is judged that the volume of information of the vehicle surroundings is small enough for output as visual information.

The controller 40 controls the volume of information of the output information based on the calculated volume of information of the vehicle surroundings (step S106).

Based on the calculated volume of information of the vehicle surroundings, the controller 40 causes an appropriate display among the three displays configuring the output interface 50 to output the output information (step S107). The controller 40 causes at least one of the three displays to display the aforementioned types of output content.

The controller 40 determines the output information to be audio information when it is judged that output as visual information is not possible (step S108). The controller 40 determines the output information to be audio information when it is judged that the volume of information of the vehicle surroundings is not small enough for output as visual information.

The controller 40 controls the volume of information of the output information based on the calculated volume of information of the vehicle surroundings (step S109).

Based on the calculated volume of information of the vehicle surroundings, the controller 40 causes an appropriate speaker, between the two speakers 51a, 51b configuring the output interface 50, to output the output information (step S110). The controller 40 causes at least one of the two speakers 51a, 51b to play back the aforementioned types of output content.

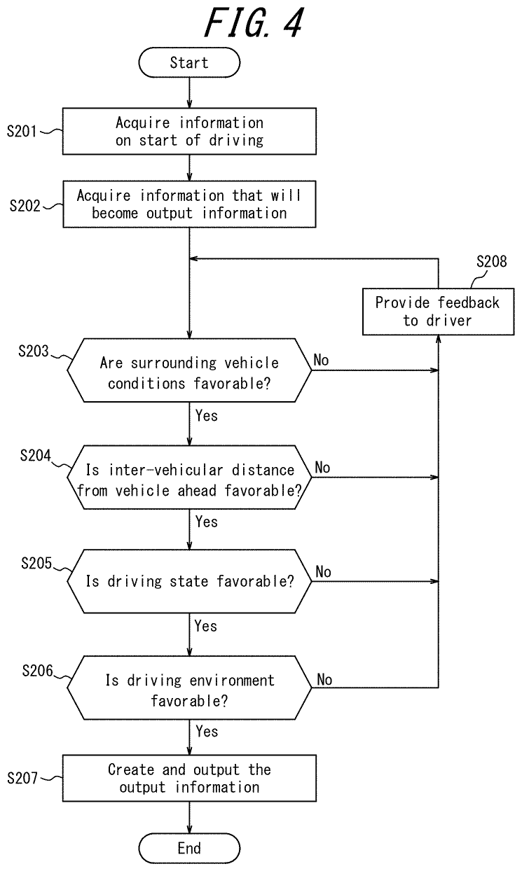

FIG. 4 is a second flowchart illustrating an example of output information control performed by the controller 40 of FIG. 1. An example of the processing performed by the controller 40 using the vehicle information acquisition interface 10 and the driver information acquisition interface 20 is described with reference to FIG. 4. The flowchart of FIG. 3 is a more detailed explanation of step S207 of the flowchart illustrated in FIG. 4.

For example, the case of the vehicle starting to drive on a highway is considered. The controller 40 acquires information related to the start of driving on the highway from the vehicle information acquisition interface 10 (step S201).

The controller 40 acquires information that will become output information (step S202). For example, the controller 40 acquires information related to a received SNS message.

The controller 40 judges whether the surrounding vehicle conditions are favorable via the vehicle information acquisition interface 10, e.g. the surrounding information acquisition interface 11 (step S203). The controller 40 proceeds to step S204 when judging that the surrounding vehicle conditions are favorable. For example, the controller 40 judges that the surrounding vehicle conditions are favorable when only one vehicle ahead is within a radius of 200 m centered on the respective vehicle. The controller 40 proceeds to step S208 when judging that the surrounding vehicle conditions are unfavorable. For example, the controller 40 judges that the surrounding vehicle conditions are unfavorable when a vehicle is located 20 m behind and a vehicle in parallel is driving in the right lane.

The controller 40 judges whether the inter-vehicular distance from the vehicle ahead is favorable via the vehicle information acquisition interface 10, e.g. the surrounding information acquisition interface 11 (step S204). The controller 40 proceeds to step S205 when judging that the inter-vehicular distance from the vehicle ahead is favorable. For example, the controller 40 judges that the inter-vehicular distance from the vehicle ahead is favorable when the time to collision (TTC) with the vehicle ahead or the time headway (THW) is 2.5 s or more. The controller 40 proceeds to step S208 when judging that the inter-vehicular distance from the vehicle ahead is unfavorable. For example, the controller 40 judges that the inter-vehicular distance from the vehicle ahead is unfavorable when the TTC or the THW is shorter than 2.5 s.

The controller 40 judges whether the driving state of the driver is favorable via the driver information acquisition interface 20 (step S205). The controller 40 proceeds to step S206 when judging that the driving state is favorable. For example, the controller 40 judges that the driving state is favorable when the driving behavior has not changed from the driving behavior during safe conditions. The controller 40 proceeds to step S208 when judging that the driving state is unfavorable. For example, the controller 40 judges that the driving state is unfavorable when the forward viewing time of the driver is short or when changes in the line of driving are abrupt. In these cases, the controller 40 may refer to information related to the driving state from several seconds before based on data related to driving behavior stored as time series data in the storage 30 or the like.

The controller 40 judges whether the driving environment is favorable via the vehicle information acquisition interface 10 (step S206). The controller 40 proceeds to step S207 when judging that the driving environment is favorable. For example, when no change in the driving environment that would greatly affect driving operations will occur within 2.5 s, the controller 40 judges that the driving environment is favorable. The controller 40 proceeds to step S208 when judging that the driving environment is unfavorable. For example, the controller 40 judges that the driving environment is unfavorable when the vehicle is currently being driven, or is expected to be driven several seconds later, on a sharp curve, a merging point, or a tunnel. In such cases, the controller 40 may refer to map data stored in the storage 30 or the like or GPS information acquired by the vehicle position acquisition interface 12.

The controller 40 creates and outputs the output information (step S207). As one example, the controller 40 creates and outputs the output information following the flowchart in FIG. 3. The controller 40 outputs information viewable in 1.8 s, for example, to the HUD 52a.

The controller 40 provides feedback to the driver when the result of each of the aforementioned judgments is unfavorable (step S208). For example, the controller 40 notifies the driver how to obtain a favorable result in each of the aforementioned judgments. The controller 40 may, for example, use audio, ambient display, a pull icon, or the like to provide the driver with notifications such as “increase inter-vehicular distance from the vehicle ahead”, “exit the curve in 100 m”, and “steer steadily”.

The above-described information control apparatus 1 can optimize control of output information based on the volume of information of the vehicle surroundings. Based on the volume of information of the vehicle surroundings, the information control apparatus 1 changes at least one of whether output information is on or off, the output format, the volume of information, and the output position as necessary. Information can thereby be provided so as not to become a large burden on the driver in accordance with the surrounding environment of the vehicle. For example, unlike a known configuration, the information control apparatus 1 can provide information safely even when the volume of information of the vehicle surroundings is small, and the driver feels comfortable while driving and does not find the output of information to be problematic. Received output information of which, until now, the driver had been notified independently from the surrounding environment of the vehicle can be acquired by the driver at a safe timing in conjunction with the surrounding environment of the vehicle.

The information control apparatus 1 can provide information to the driver more safely by controlling the output information based on the safety of the vehicle surroundings. By predicting the safety of the vehicle surroundings based on a plurality of other factors in addition to the volume of information of the vehicle surroundings, the information control apparatus 1 can provide information to the driver in a state that more accurately matches the surrounding environment of the vehicle. In other words, the information control apparatus 1 can provide information to the driver in accordance with the surrounding environment of the vehicle in a more suitable manner.

The information control apparatus 1 can improve driving-related safety by turning output related to output information on or off. The information control apparatus 1 does not output the output information when the volume of information of the vehicle surroundings is excessively large but does output the output information when the volume of information of the vehicle surroundings is not excessively large. This can reduce the burden on the driver. The driver can concentrate only on driving when the surrounding environment of the vehicle is complex and can acquire necessary information when the surrounding environment of the vehicle is relatively calm.

The information control apparatus 1 can reduce the burden on the driver for recognizing information while driving by controlling the volume of information of the output information. The information control apparatus 1 can output the output information in the optimal mode taking into account the volume of information of the vehicle surroundings. The information control apparatus 1 can output the output information with an optimal volume of information while securing driver safety.

The information control apparatus 1 can measure the volume of information of the output information more objectively by defining the volume of information according to the chunk count. The information control apparatus 1 can thereby control the volume of information of the output information more accurately.

The information control apparatus 1 can reduce the burden on the driver for recognizing information while driving by controlling the output position based on the volume of information of the vehicle surroundings. The driver can continue to focus on driving, with little loss of concentration, even when the volume of information of the vehicle surroundings is relatively large if output information is displayed on the HUD 52a that overlaps the driver's field of view, for example. Conversely, when the volume of information of the vehicle surroundings is relatively small, then output information with a large volume of information can be outputted on the center display 52c that has a relatively large display screen. The driver can then easily grasp an overview of the information while experiencing only a small burden.

The information control apparatus 1 can provide information to the driver in an optimal form in accordance with the volume of information of the vehicle surroundings by controlling the output format of the output information. For example, output information can be outputted as audio information when the volume of information of the vehicle surroundings is greater than a predetermined volume. This allows the driver to acquire necessary information as audio, without diverting the line of sight. Conversely, by the output information being outputted as visual information when the volume of information of the vehicle surroundings is less than a predetermined volume, the driver can visually confirm necessary information at an optimal timing. In this way, the information control apparatus 1 can reliably provide the driver with necessary information in a state that reduces the burden on the driver.

As the driver-related information, the information control apparatus 1 acquires information related to operation by the driver and information related to the operation intention of the driver. This allows output information to be controlled highly accurately in accordance with individual drivers. For example, the information control apparatus 1 can provide information in an optimal state in conjunction with the driver's degree of driving experience. The information control apparatus 1 can similarly control the output information highly accurately in accordance with an individual driver by acquiring information related to other states of the driver as the driver-related information. For example, the information control apparatus 1 can provide information in an optimal state in conjunction with the driver's physical condition on a given day.

The information control apparatus 1 can extract only the information that is particularly necessary by reducing the volume of information as a result of at least one of summarizing and extracting the output information. This allows the driver to learn just the essential points of the output information precisely. The driver can obtain an overview of necessary information at the optimal timing in accordance with the environment around the vehicle.

Although the present disclosure has been explained with reference to the drawings and examples, it is to be noted that various changes and modifications will be apparent to those of ordinary skill in the art based on the present disclosure. Therefore, such changes and modifications are to be understood as included within the scope of the present disclosure. For example, the functions and the like included in the various means and steps may be reordered in any logically consistent way. Means or steps may also be combined into one or divided.

For example, the information control apparatus 1 has been described as determining the output information to be audio information when the volume of information of the vehicle surroundings is larger than a predetermined volume and determining the output information to be visual information when the volume of information of the vehicle surroundings is smaller than a predetermined volume. However, this configuration is not limiting. The information control apparatus 1 may reverse the output format of the output information, as long as doing so does not negatively affect driving safety, by determining the output information to be visual information when the volume of information of the vehicle surroundings is larger than a predetermined volume and determining the output information to be audio information when the volume of information of the vehicle surroundings is smaller than a predetermined volume.

In the flowchart in FIG. 4, the information control apparatus 1 has been described as creating and outputting the output information only when all four judgments are favorable, but this configuration is not limiting. The information control apparatus 1 may create and output the output information even if not all four judgments are favorable, as long as the output information can be controlled accurately in accordance with the volume of information of the vehicle surroundings.

### REFERENCE SIGNS LIST

1 Information control apparatus
10 Vehicle information acquisition interface
11 Surrounding information acquisition interface
12 Vehicle position acquisition interface
20 Driver information acquisition interface
30 Storage
40 Controller
50 Output interface
51a, 51b Speaker
52a HUD
52b Meter display
52c Center display

1. An information control apparatus comprising:
a vehicle information acquisition interface configured to acquire information related to a vehicle and vehicle surroundings;
a driver information acquisition interface configured to acquire information related to a driver; and
a controller configured to:
control information to be received from outside the vehicle and outputted to the driver based on the information related to the vehicle and the vehicle surroundings or the information related to the driver; and
control output information to be outputted as audio information and not outputted as visual information when a controlled volume of information is greater than a predetermined volume.

2. The information control apparatus of claim 1, wherein the controller is configured to predict safety of the vehicle surroundings based on the information related to the vehicle and the vehicle surroundings and the information related to the driver and to control the output information based on the safety.

3. The information control apparatus of claim 1, wherein the controller is configured to turn output related to the output information on or off.

4. The information control apparatus of claim 1, wherein the controller is configured to control a volume of information of the output information.

5. The information control apparatus of claim 4, wherein the volume of information of the output information is determined by a chunk count defined by a character count, a word count, a count of phrases, icons, and figures, or a count of attention points in graphic form.

6. The information control apparatus of claim 1, wherein the controller is configured to control an output position of the output information.

7. The information control apparatus of claim 1, wherein the controller is configured to control an output format of the output information.

8. (canceled)

9. The information control apparatus of claim 7, wherein the output information is outputted as visual information when the controlled volume of information is smaller than a predetermined volume.

10. The information control apparatus of claim 1, wherein as the information related to the driver, the driver information acquisition interface is configured to acquire information related to an operation intention of the driver based on information related to an operation by the driver and the information related to the vehicle and the vehicle surroundings acquired by the vehicle information acquisition interface.

11. The information control apparatus of claim 1, wherein the information related to the driver is information related to an operation by the driver.

12. The information control apparatus of claim 1, wherein the predetermined volume is a limit on a volume of information of the vehicle surroundings such that outputting the output information as visual information does not place a burden on the driver.
